(19) United States
(12) Patent Application Publication
(10) Pub. No.: US 2010/0317311 A1
(43) Pub. Date: Dec. 16, 2010

(54) Protection for SAW-Less Receivers

(75) Inventors: Ahmad MIRZAEI, Costa Mesa, CA (US); Hooman DARABI, Irvine, CA (US); Yuyu CHANG, Irvine, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Broadcom Corporation, Irvine, CA (US)

(21) Appl. No.: 12/481,702

(22) Filed: Jun. 10, 2009

(51) Int. Cl. H04B 1/10

(52) U.S. Cl. 455/307

(57) ABSTRACT

Embodiments of a SAW-less RF receiver front-end that includes a frequency translated notch filter (FTNF) are presented. An FTNF includes a passive mixer and a baseband impedance. The baseband impedance includes capacitors that form a low-Q band-stop filter. The passive mixer is configured to translate the baseband impedance to a higher frequency. The translated baseband impedance forms a high-Q notch filter and is presented at the input of the FTNF. The FTNF can be fully integrated in CMOS IC technology (or others, e.g., Bipolar, BiCMOS, and SiGe) and applied in wireless receiver systems including GSM, EDGE, Wideband Code Division Multiple Access (WCDMA), Bluetooth, and wireless LANs (e.g., IEEE 802.11). In addition, embodiments of an apparatus to protect SAW-less RF receiver front-ends are presented.

### FIELD OF THE INVENTION

This application relates generally to radio frequency (RF) receivers and, more specifically, to the protection of SAW-less RF receivers.

### BACKGROUND

There exist two commonly implemented front-end architectures in radio frequency (RF) receiver design; namely, the homodyne architecture and the heterodyne architecture. The homodyne architecture down-converts a desired channel directly from RF to baseband, whereas the heterodyne architecture down-converts a desired channel to one or more intermediate frequencies (IF) before down-conversion to baseband. In general, each of these front-end architectures typically employ an antenna to receive an RF signal, a band-pass filter to suppress out-of-band interferers in the received RF signal, a low noise amplifier (LNA) to provide gain to the filtered RF signal, and one or more down-conversion stages.

Each component in a receiver front-end contributes noise to the overall system. The noise of a component can be characterized by its noise factor (F), which is given by the ratio of the SNR at the input of the component to the SNR at the output of the component:

F_{COMPONENT}=SNR_{IN}/SNR_{OUT}

The noise of the overall receiver front-end increases from input to output as noise from successive components compound. In general, the overall noise factor of the receiver front-end is proportional to the sum of each component's noise factor divided by the cascaded gain of preceding components and is given by:

$${F}_{TOTAL} = {F}_{1} + \frac{{F}_{2 - 1} - 1}{{A}_{1}} + \frac{{F}_{3 - 1} - 1}{{A}_{1} {A}_{2}} + … + \frac{{F}_{n - 1} - 1}{{A}_{1} {A}_{2} … {A}_{n - 1}}$$

where Fₙ and Aₙ represent the noise factor and gain of the nth component in the receiver front-end, respectively. The above equation reveals that the noise factor (F₁) and gain (A₁) of the first gain component can have a dominant effect on the overall noise factor of the receiver front-end, since the noise contributed by each successive component is diminished by the cascaded gain of the components that precede it.

To provide adequate sensitivity, therefore, it is important to keep the noise factor (F₁) low and the gain (A₁) high of the first gain component in the receiver front-end. The sensitivity of the receiver front-end determines the minimum signal level that can be detected and is limited by the overall noise factor of the receiver front-end. Thus, in typical receiver designs the first gain component in the front-end is an LNA, which can provide high gain, while contributing low noise to the overall RF receiver.

LNAs provide relatively linear gain for small signal inputs. However, for sufficiently large input signals, LNAs can exhibit non-linear behavior in the form of gain compression; that is, for sufficiently large input signals, the gain of the LNA approaches zero. LNA gain compression is a common issue confronted in RF receiver design, since large out-of-band interferers referred to as blockers can accompany a comparatively weak desired signal in a received RF signal. For example, in the Global System for Mobile Communications (GSM) standard, a desired signal 3 dB above sensitivity (−102 dBm) can be accompanied by a 0 dBm blocker as close as 80 MHz away. If these large out-of-band interferers are not attenuated prior to reaching the LNA, they can reduce the average gain of the LNA. As noted above, a reduction in the gain provided by the LNA leads to an increase in the noise factor of the receiver front-end and a corresponding degradation in sensitivity.

Therefore, a band-pass filter is conventionally employed in the receiver front-end, before the LNA, to attenuate large out-of-band interferers. These filters are typically mechanically-resonant devices, such as surface acoustic wave (SAW) filters, that provide a high quality factor (Q) required by many of today's communication standards (e.g., GSM). The Q-factor of a tuned circuit, such as a band-pass filter, is the ratio of its resonant frequency (or center frequency) to its 3 dB frequency bandwidth. SAW filters are generally not amenable to monolithic integration on a semiconductor substrate with the RF receiver. However, SAW filters remain conventional in RF receiver design because of the limited Q-factor of silicon-based inductors.

Although SAW filters can provide excellent attenuation of large out-of-band interferers and accurate pass-band location, they have several associated disadvantages. First, these filters have an approximate insertion loss of 1-2 dB in their pass-band. This directly adds to the noise factor and degrades sensitivity of the RF receiver. Second, these filters invariably add cost and circuit board area, especially in multi-band applications where several of these filters can be required. Third, these filters remove the flexibility of sharing LNAs in multi-band applications.

Therefore, there exists a need for an apparatus that provides adequate attenuation of large out-of-band interferers on a semiconductor substrate, while allowing LNAs to be shared in multi-band applications.

Although several benefits can be realized by the removal of the conventional off-chip SAW filter, portions of a SAW-less RF receiver front-end, disposed on a semiconductor substrate, are now susceptible to large out-of-band interferers. Specifically, out-band-signals received by the RF receiver front-end can be as large as 27 dBm. These large out-of-band interferers can originate from many sources, including transmitters within close proximity of the receiver and even a transmitter associated with the RF receiver front-end (in a transceiver configuration). Without attenuation of these large out-of-band interferers, before reaching the semiconductor substrate of the RF receiver front-end, devices (e.g., transistors) within the semiconductor substrate can be exposed to over-voltages; that is, voltages which exceed design limits. These over-voltage situations can accelerate aging and/or result in breakdown of devices within the RF receiver front-end. Breakdown of devices can, in a worst case scenario, result in an unrecoverable failure of the RF receiver front-end.

In the conventional RF receiver front-end, the SAW filter generally provides attenuation of these large out-of-band interferers prior to reaching the input terminal or pin of the semiconductor substrate. Therefore, what is further needed is an apparatus to protect SAW-less RF receiver front-ends.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an exemplary RF receiver front-end that provides for suppression of out-of-band interferers on a semiconductor substrate, according to embodiments of the present invention.

FIG. 2 illustrates an circuit-level implementation of a frequency translated notch filter (FTNF), according to embodiments of the present invention.

FIG. 3 illustrates the magnitude and phase relationship of the baseband impedance (Z_{BB}) and the translated baseband impedance (Z_{IN}) of the FTNF presented in FIG. 2, according to embodiments of the present invention.

FIG. 4 illustrates a waveform diagram of exemplary LO signals for use by the passive mixer illustrated in FIG. 2, according to embodiments of the present invention.

FIG. 5 illustrates a SAW-less RF receiver front-end that includes circuitry for protection from large out-of-band interferers, according to embodiments of the present invention.

FIG. 6 illustrates a SAW-less RF receiver front-end that includes circuitry for protection from large out-of-band interferers, according to embodiments of the present invention.

FIG. 7 illustrates a SAW-less RF receiver front-end that includes circuitry for protection from large out-of-band interferers, according to embodiments of the present invention.

FIG. 8 illustrates a SAW-less RF receiver front-end that includes circuitry for protection from large out-of-band interferers, according to embodiments of the present invention.

The present invention will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the invention. However, it will be apparent to those skilled in the art that the invention, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### 1. SAW-Less RF Receiver Front-End

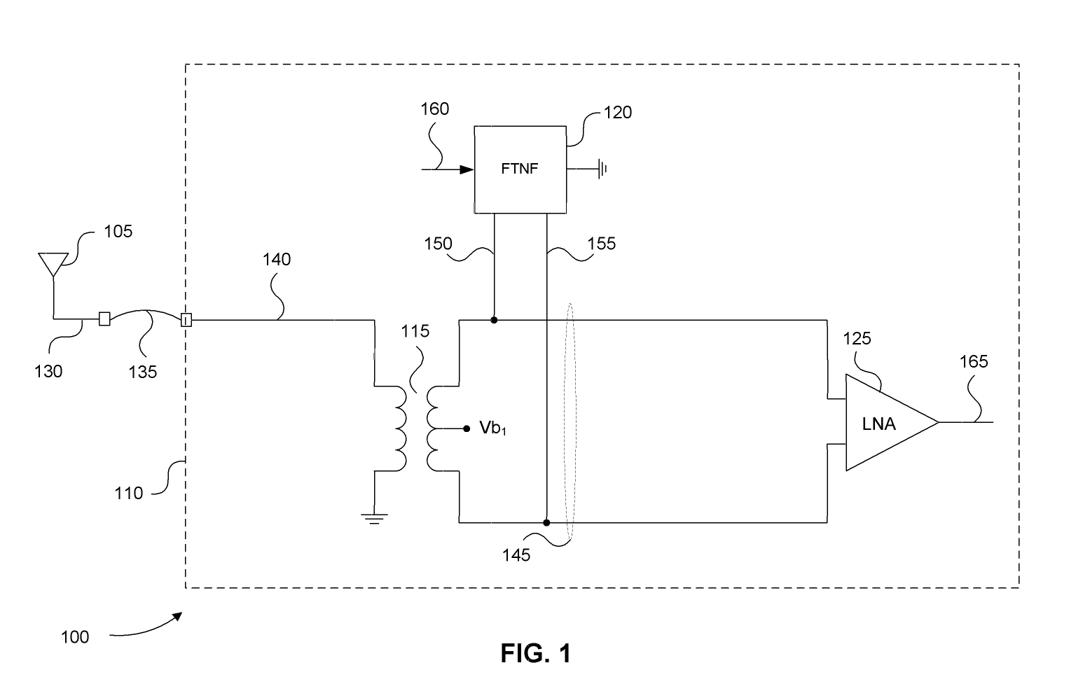

FIG. 1 illustrates an exemplary RF receiver front-end 100 that provides for suppression of out-of-band interferers on a semiconductor substrate, according to embodiments of the present invention. RF receiver front-end 100 includes an antenna 105, a semiconductor substrate 110, a balun transformer 115, a frequency translated notch filter (FTNF) 120, and a low noise amplifier (LNA) 125.

RF receiver front-end 100 receives at antenna 105 an RF signal that includes a desired channel. In an embodiment, the desired channel is positioned within a frequency band defined by a particular communications standard. For example, the desired channel can be positioned within a frequency band defined by the GSM standard, such as the Global System for Mobile Communications 900 (GSM-900) band, the Digital Cellular System 1800 (DCS-1800) band, or the Personal Communications Services 1900 (PCS-1900) band. The RF signal is provided via antenna coupling 130 to bond wire 135. Bond wire 135 couples the RF signal to an input terminal or pin of semiconductor substrate 110.

After reaching the input terminal of semiconductor substrate 110, the RF signal is coupled to single-ended RF signal path 140. Balun transformer 115 receives the RF signal at single-ended RF signal path 140 and transforms the RF signal into a differential RF signal. The differential RF signal is coupled to differential RF signal path 145 that includes positive-end 150 and negative-end 155. In an embodiment, bias voltage V_{b1} of balun transformer 115 is capacitively coupled to ground potential.

The differential RF signal is provided to FTNF 120 to attenuate interferers outside the band containing the desired channel. FTNF 120 includes a passive mixer (not shown) and a baseband impedance (not shown) that forms a low-Q band-stop filter. The passive mixer is configured to translate the baseband impedance to a higher frequency by an amount substantially equal to the frequency of a 25% duty cycle local oscillator (LO) signal received at LO coupling 160. The translated impedance forms a high-Q notch filter coupled between the differential RF signal, received via differential RF signal path 145, and ground.

In general, a notch filter is a band-stop filter with a narrow stop-band (the “notch” of the filter represents the stop-band). Frequency components of a signal applied at the input of the notch filter that fall within the stop-band are substantially precluded from being passed through to the filter output. Conversely, all other frequency components of the signal outside the stop-band are substantially passed through to the filter output. As illustrated in FIG. 1, the input of FTNF 120 is coupled to differential RF signal path 145 and the output of FTNF 120 is coupled to ground.

The notch presented by FTNF 120 can be tuned to (i.e., centered within) either the frequency band of the differential RF signal that contains the desired channel or to the desired channel itself. Specifically, the 25% duty cycle LO signal received at LO coupling 160 can be adjusted to have a frequency substantially equal to either the center frequency of the band containing the desired channel or to the center frequency of the desired channel itself. Moreover, the bandwidth of the notch presented by FTNF 120 can be designed to encompass either the band containing the desired channel or the desired channel itself. In this way, FTNF 120 can present a high-impedance path to ground for either the entire frequency band containing the desired channel or to the desired channel itself, and a low impedance path to ground for out-of-band interferers.

Since out-of-band interferers will not develop any substantial voltage across the impedance provided by FTNF 120, they will be attenuated. Frequency components within the notch of FTNF 120, however, will develop a substantial voltage across the impedance provided by FTNF 120 and, thus, will be provided to LNA 125 for further processing.

In conventional RF receiver front-ends, the RF signal is typically filtered by a high-Q RF filter (e.g., a SAW filter) prior to reaching the input terminal of semiconductor substrate 110. In general, the limited Q of silicon-based inductors has thus far prevented the practical integration of a high-Q RF filter on a semiconductor substrate, such as semiconductor substrate 110. FTNF 120 overcomes these previous limitations and provides one practical implementation of a high-Q RF filter for integration on a semiconductor substrate.

After undergoing filtering by FTNF 120, LNA 125 receives the RF signal via differential RF signal path 145 and provides sufficient amplification to the desired channel of the RF signal to overcome the noise of subsequent stages. The amplified RF signal is provided at LNA output 165 for further processing (e.g., frequency conversion and baseband processing). LNA output 165 can be either single-ended or differential. The operation of FTNF 120 is further described in U.S. patent application Ser. No. 12/470,789, the disclosure of which is incorporated herein by reference.

It should be noted that FTNF 120 can be configured to receive and process a single-ended RF signal and can be coupled to single-ended RF signal path 140. It should be further noted that one or more FTNFs, such as FTNF 120, can be implemented in RF receiver front-end 100. For example, an additional FTNF 120 can be implemented between an input stage and a cascode stage of LNA 125 to attenuate any residual out-of-band interferers.

### 2. Frequency Translated Notch Filter

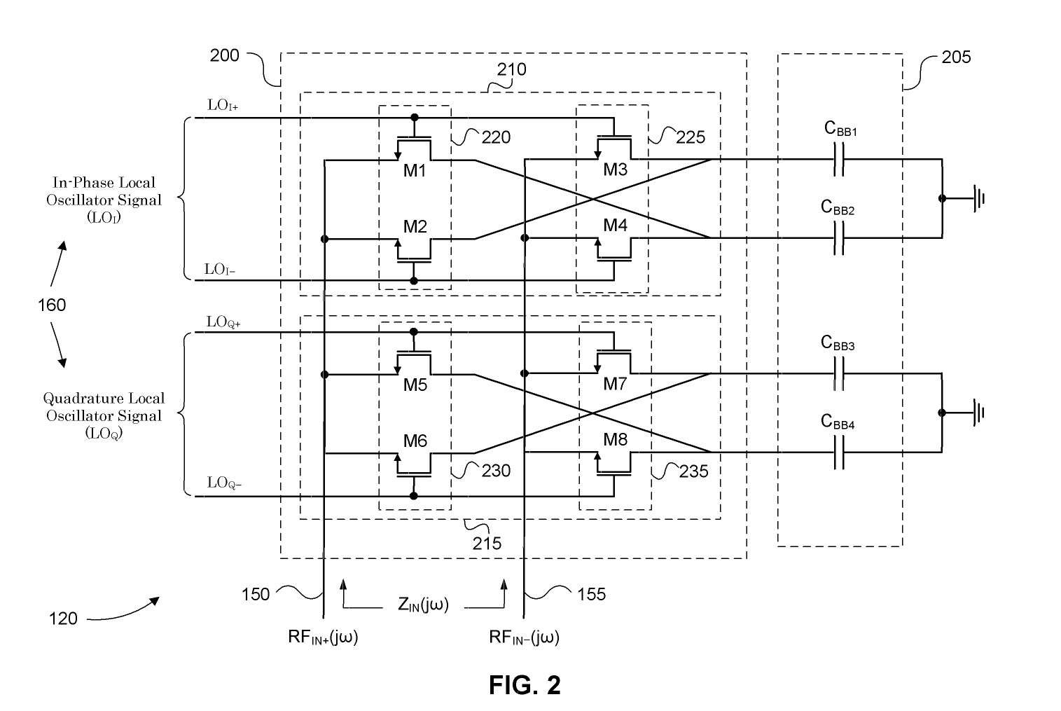

FIG. 2 illustrates an exemplary implementation of differential frequency translated notch filter (FTNF) 120, according to embodiments of the present invention. FTNF 120 is differential in that it processes a differential RF signal (RF_{IN+} and RF_{IN}) received at differential input pair 150 and 155. FTNF 120 includes a passive mixer 200 and a baseband impedance (Z_{BB}) 205. Baseband impedance 205 includes capacitors C_{BB1}, C_{BB2}, C_{BB3}, and C_{BB4} that form a low-Q band-stop filter. Passive mixer 200 is configured to translate baseband impedance 205 to a higher frequency. The translated baseband impedance (Z_{IN}) forms a high-Q band-stop filter (i.e., a notch filter) that is presented at differential input pair 150 and 155.

Passive mixer 200 includes a double-balanced mixer 210 and a double-balanced mixer 215. Double-balanced mixer 210 includes switching devices M1, M2, M3, and M4. Double-balanced mixer 215 includes switching devices M5, M6, M7, and M8. In an embodiment, switching devices M1-M8 are metal-oxide semiconductor field effect transistors (MOSFETs). Specifically, switching devices M1-M8 are n-channel MOSFETs (NMOS). However, as will be appreciated by one of ordinary skill in the art, switching devices M1-M8 can be implemented using any suitable switching device, including p-channel MOSFETs (PMOS), bipolar junction transistors (BJTs) and junction gate field effect transistors (JFETs). In the embodiment of FIG. 2, switches M1-M8 are operated substantially in their linear mode when ON.

Double-balanced mixer 210 receives a differential, in-phase LO signal (LO_{I}) at LO coupling 160. The in-phase LO signal has a frequency of ω_{LO} and a duty-cycle substantially equal to 25%. Double-balanced mixer 210 is essentially formed from two single-balanced mixers 220 and 225. The gates of switching devices M1 and M3 are coupled to the positive in-phase LO signal (LO_{I+}), and the gates of switching devices M3 and M4 are coupled to the negative in-phase LO signal (LO_{I-}). Because the two in-phase LO signals (LO_{I+} and LO_{I-}) are substantially 180-degrees out of phase, switching device pair M1 and M2 and switching device pair M3 and M4 are switched ON and OFF at non-overlapping intervals at the frequency of the in-phase LO signal (ω_{LO}). The non-overlapping switching at a frequency of ω_{LO} effectively multiplies the positive RF signal (RF_{IN+}), coupled to the sources of switching devices M1 and M2, and the negative RF signal (RF_{IN-}), coupled to the sources of switching devices M3 and M4, by ±1. This effective multiplication results in frequency conversion of the differential RF signal by the sum (ω_{RF}+ω_{LO}) and difference (ω_{RF}−ω_{LO} or ω_{LO}−ω_{RF}) in frequency between the in-phase LO signal (LO_{I}) and the differential RF signal. The frequency-converted in-phase component of the RF signal is provided differentially to baseband impedance 205.

Double-balanced mixer 215 receives a differential, quadrature LO signal (LO_{Q}) at LO coupling 160. The quadrature LO signal has a frequency of ω_{LO} and a duty-cycle substantially equal to 25%. Double-balanced mixer 215 is essentially formed from two single-balanced mixers 230 and 235. The gates of switching devices M5 and M7 are coupled to the positive quadrature LO signal (LO_{Q+}), and the gates of switching devices M6 and M8 are coupled to the negative quadrature LO signal (LO_{Q-}). Because the two quadrature LO signals (LO_{Q+} and LO_{Q-}) are substantially 180-degrees out of phase, switching device pair M5 and M6 and switching device pair M7 and M8 are switched ON and OFF at non-overlapping intervals at the frequency of the quadrature LO signal (ω_{LO}). The non-overlapping switching at a frequency of ω_{LO} effectively multiplies the positive RF signal (RF_{IN+}), coupled to the sources of switching devices M5 and M6, and the negative RF signal (RF_{IN+}), coupled to the sources of switching devices M7 and M8, by ±1. This effective multiplication results in frequency conversion of the differential RF signal by the sum (ω_{RF}+ω_{LO}) and difference (ω_{RF}−ω_{LO} or ω_{LO}−ω_{RF}) in frequency between the quadrature LO signal (LO_{Q}) and the differential RF signal. The frequency-converted quadrature component of the RF signal is provided differentially to baseband impedance 205.

The use of double-balanced mixers 210 and 215 effectively removes any DC offset component of the in-phase and quadrature LO signals, as well as any DC offset component of the differential RF signal. Removal of the DC components helps to reduce undesired feed-through of the RF signal and the LO signal at the output of double-balanced mixers 210 and 215.

As noted above, baseband impedance 205 includes capacitors C_{BB1}, C_{BB2}, C_{BB3}, and C_{BB4} that are respectively coupled between the drains of transistors M1-M8 and ground. In an embodiment, the capacitors C_{BB1}, C_{BB2}, C_{BB3}, and C_{BB4} are each substantially equivalent and their impedances are given by (ignoring parasitics):

$${Z}_{BB} ( j ω ) = \frac{1}{j ω C}$$

where j is the imaginary unit, ω is the frequency of the signal applied across the capacitor, and C is the capacitance. As is readily apparent from the above, for DC signals, Z_{BB} presents an extremely large impedance. However, as the frequency of the applied signal moves in either the positive or negative direction, away from DC (i.e., 0-MHz), the impedance Z_{BB} decreases. Thus, capacitors C_{BB1}, C_{BB2}, C_{BB3}, and C_{BB4}, effectively form a low-Q band-stop filter centered at baseband.

Since the impedance of capacitors C_{BB1}, C_{BB2}, C_{BB3}, and C_{BB4} varies with the frequency of the signal applied across their terminals, it follows that the frequency conversion of the differential RF signal by passive mixer 200 alters the impedance seen by the differential RF signal at differential input pair 150 and 155. Specifically, the impedance of capacitors C_{BB1}, C_{BB2}, C_{BB3}, and C_{BB4} will each appear translated by ±ω_{LO} as seen by the differential RF signal at differential input pair 150 and 155; that is, the low-Q band-stop filter formed by baseband impedance 205, is substantially translated by ±ω_{LO} and becomes a high-Q band-stop filter presented at differential input pair 150 and 155. A high-Q band-stop filter is commonly referred to as a notch filter.

It can be shown that the translated baseband impedance (Z_{IN}) is substantially given by:

$${Z}_{IN} ( j {ω}_{RF} ) = {R}_{SW} + \frac{4}{{π}^{2}} \frac{j {ω}_{RF}}{{C}_{BB} \{ {( j {ω}_{RF} )}^{2} + {ω}_{LO}^{2} \}}$$

where ω_{RF} is the frequency of the differential RF signal received at differential input pair 150 and 155, ω_{LO} is the frequency of the LO signal received at LO coupling 160, and R_{SW} is the switch resistance of transistors M1-M8.

In an embodiment, Z_{IN} is determined such that differential input pair 150 and 155 presents a high-impedance path to ground for frequency components of the differential RF signal within a desired frequency band and a low-impedance path to ground for frequency components of the differential RF signal outside the desired frequency band. The high-impedance (i.e., the notch) effectively precludes frequency components of the differential RF signal, within the desired frequency band from being attenuated. Conversely, the low-impedance effectively allows frequency components of the differential RF signal outside the desired frequency band to be attenuated. In other words, frequency components of the differential RF signal outside the desired frequency band are filtered. The desired frequency band can be taken as an output at differential input pair 150 and 155, because the undesired frequency components have been shunted to ground.

Low-Q capacitive impedances, such as C_{BB1}, C_{BB2}, C_{BB3}, and C_{BB4}, are readily capable of monolithic integration on a common semiconductor substrate together with passive mixer 200. Therefore, FTNF 120 provides a suitable notch filter implementation for integration on a semiconductor substrate, such as semiconductor substrate 110 of FIG. 1.

It should be emphasized that FTNF 120 can be fully integrated in CMOS IC technology (or others, e.g., Bipolar, BiCMOS, and SiGe) and applied in wireless receiver systems including GSM, EDGE, WCDMA, Bluetooth, and wireless LANs (e.g., IEEE 802.11). In addition, as would be apparent to one of ordinary skill in the art based on the teachings herein, FTNF 120 can be modified to be single-ended and used to filter a single-ended RF signal.

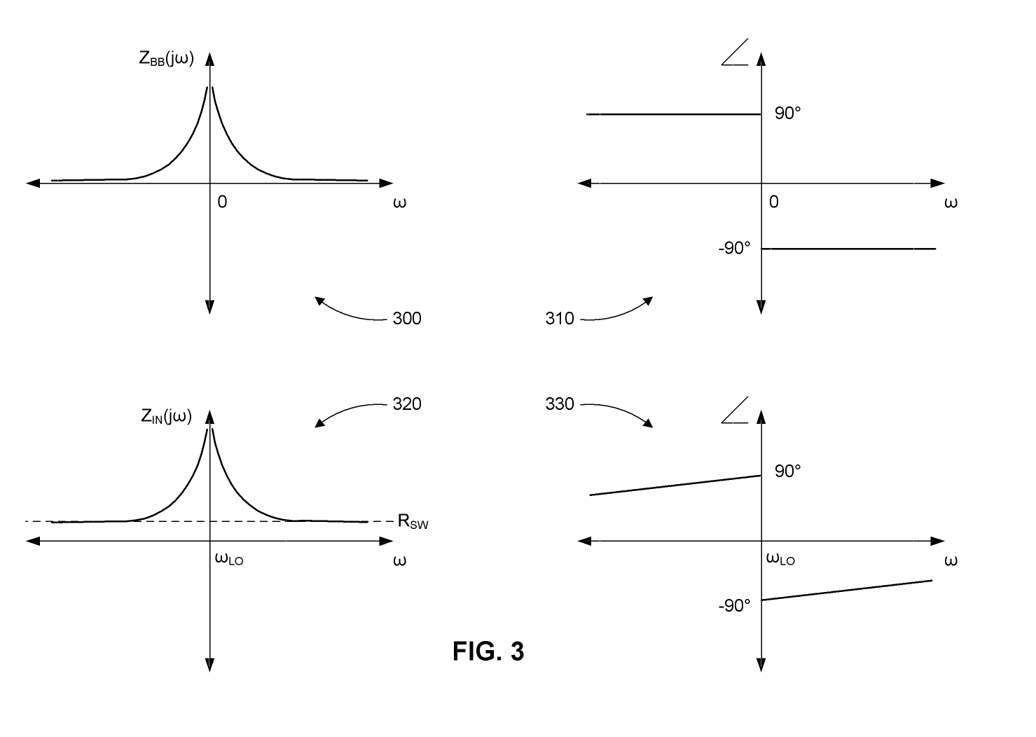

FIG. 3 illustrates the magnitude and phase relationship of baseband impedance 205 (Z_{BB}) and the translated baseband impedance (Z_{IN}) of FIG. 2, according to embodiments of the present invention. Baseband impedance 205 has a frequency versus magnitude response 300 and a frequency versus phase response 310. For DC signals, Z_{BB} presents an extremely large impedance. However, as the frequency of the applied signal moves in either the positive or negative direction, away from DC (i.e., 0-MHz), the impedance Z_{BB} decreases. Thus, Z_{BB} effectively forms a low-Q band-stop filter centered at baseband.

Frequency translated baseband impedance (Z_{IN}) has a frequency versus magnitude response 320 and a frequency versus phase response 330. The frequency versus magnitude response 330 clearly illustrates that the baseband impedance 320 has been substantially translated by ω_{LO} (only positive frequencies are illustrated in 320). For an applied signal at or near ω_{LO}, Z_{IN} presents an extremely large impedance. However, as the frequency of the applied signal moves in either the positive or negative direction, away from ω_{LO}, the impedance Z_{IN} quickly decreases to substantially the switch resistance R_{SW} of switching devices M1-M8. Thus, Z_{IN} effectively forms a high-Q band-stop filter (i.e., a notch filter) centered at ω_{LO}.

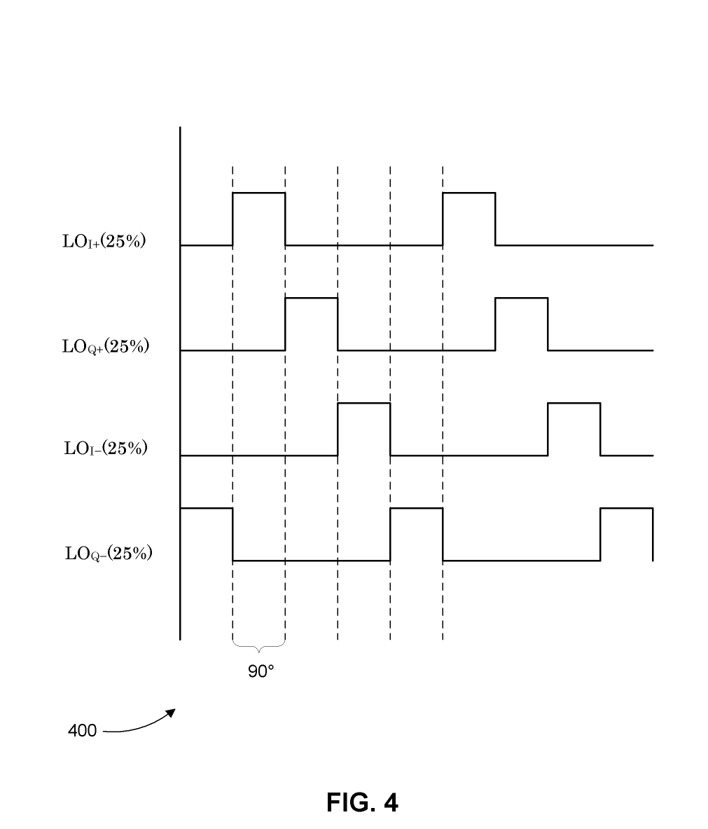

FIG. 4 illustrates a waveform diagram of exemplary LO signals 400 for use by passive mixer 200 of FIG. 2, according to embodiments of the present invention. LO signals 400 include two differential phases of an LO signal; namely, an in-phase LO signal (LO_{I+} and LO_{I-}) and a quadrature LO signal (LO_{Q+} and LO_{Q-}). The positive in-phase LO signal (LO_{I+}) has a phase shift of substantially 90-degrees relative to the positive quadrature LO signal (LO_{Q+}), and the negative in-phase LO signal (LO_{I-}) has a phase shift of substantially 90-degrees relative to the negative quadrature LO signal (LO_{Q-}). The positive and negative ends of the differential signals LO_{I} and LO_{Q} have a phase shift of substantially 180-degrees relative to each other.

LO signals 400 each have a duty cycle substantially equal to 25%. The 25% duty cycle of LO signals 400 helps to suppress undesired images of the differential RF signal from occurring at the output of passive mixer 200. In general, the duty cycles of LO signals 400 can be greater than or less than 25%, provided that adequate image suppression is still achieved.

### 3. Protection for SAW-Less RF Receiver Front-Ends

Although FTNF 120 provides a viable, on-chip replacement for the conventional off-chip SAW filter (and other high-Q RF filters), RF receiver front-end 100 illustrated in FIG. 1 may now be susceptible to large out-of-band interferers. Specifically, large out-of-band interferers received by antenna 105 can be as large as 27 dBm. These large out-of-band interferers can originate from many sources, including nearby transmitters and even a transmitter associated with the RF receiver front-end (in a transceiver configuration). Without attenuation of these large out-of-band interferers, before reaching semiconductor substrate 110, devices (e.g., transistors) within semiconductor substrate 110 can be exposed to over-voltages; that is, voltages above design limits. These over-voltage situations can accelerate aging and/or result in breakdown of devices within RF receiver front-end 100. For example, devices within LNA 125 and FTNF 120 may be particularly vulnerable to large out- of-band interferers. Breakdown of devices can, in a worst case scenario, result in an unrecoverable failure of RF receiver front-end 100.

In the conventional RF receiver front-end, the SAW filter generally provides attenuation of these large out-of-band interferers prior to reaching the input terminal or pin of the semiconductor substrate. FTNF 120 may not be capable of providing attenuation of these large out-of-band interferers, that exceed device limits, because FTNF 120 is implemented using devices (e.g., transistors) that are susceptible to over-voltage situations. Therefore, what is needed is an apparatus to protect SAW-less RF receiver front-ends, such as SAW-less RF receiver front-end 100 presented in FIG. 1.

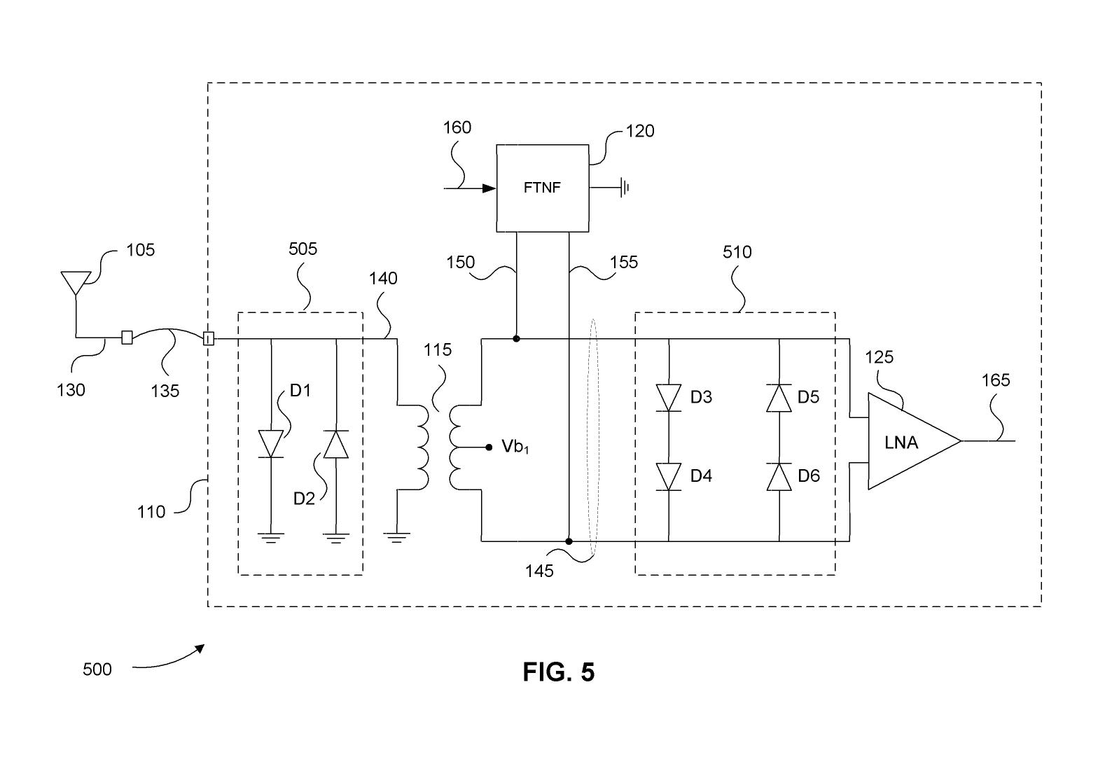

FIG. 5 illustrates a SAW-less RF receiver front-end 500 that includes circuitry for protection from large out-of-band interferers, according to embodiments of the present invention. Specifically, RF receiver front-end 500 includes two clamping circuits 505 and 510 that provide protection from large out-of-band interferers received at antenna 105.

Clamping circuit 505 protects the circuitry of RF receiver front-end 500 disposed on semiconductor substrate 110 by shunting large positive and negative voltage signals on single-ended RF signal path 140 to ground. Clamping circuit 505 includes diodes D1 and D2. The two diodes, D1 and D2, are coupled between single-ended RF signal path 140 and ground in anti-parallel.

The anode of diode D1 is coupled to single-ended RF signal path 140 and the cathode of diode D1 is coupled to ground. Diode D1 is reverse biased when the anode of diode D1, coupled to single-ended RF signal path 140, is at a voltage potential less than V_{DIODE}, where V_{DIODE} represents the turn-on voltage of diode D1. In an embodiment, V_{DIODE} is approximately equal to +0.6 V. During normal operation, the RF signal received by antenna 105 and coupled to single-ended RF signal path 140, has a voltage potential below V_{DIODE}. Therefore, diode D1 is reverse biased during normal operation of RF receiver front-end 500. Diode D1 appears as a high-impedance element (i.e., an open circuit) when diode D1 is reverse biased.

Diode D1 is forward biased when the anode of diode D1, coupled to single-ended RF signal path 140, is at a voltage potential greater than V_{DIODE}. Diode D1 appears as a low-impedance element (i.e., a short circuit) when diode D1 is forward biased. Diode D1 will be forward biased when large, positive RF signals are received at antenna 105. These large, positive RF signals, applied to the input terminal of semiconductor substrate 110, are shunted to ground by diode D1.

As further illustrated in FIG. 5, the cathode of diode D2 of clamping circuit 505 is coupled to single-ended RF signal path 140 and the anode of diode D2 is coupled to ground. Diode D2 is reverse biased when the cathode of diode D2, coupled to single-ended RF signal path 140, is at a voltage potential greater than −V_{DIODE}, where V_{DIODE} represents the turn-on voltage of diode D2. In an embodiment, −V_{DIODE} is approximately equal to −0.6 V. During normal operation, the RF signal received by antenna 105 and coupled to single-ended RF signal path 140, has a voltage potential greater than −V_{DIODE}. Therefore, diode D2 is reverse biased during normal operation of RF receiver front-end 500. Diode D2 appears as a high-impedance element (i.e., an open circuit) when diode D2 is reverse biased.

Diode D2 is forward biased when the cathode of diode D2, coupled to single-ended RF signal path 140, is at a voltage potential less than −V_{DIODE}. Diode D2 appears as a low-impedance element (i.e., a short circuit) when diode D2 is forward biased. Diode D2 will be forward biased when large, negative RF signals are received at antenna 105. These large, negative RF signals, applied to the input terminal of semiconductor substrate 110, are shunted to ground by diode D2.

Although clamping circuit 505 can effectively clamp the RF signal on single-ended RF signal path 140 to a voltage within ±V_{DIODE}, clamping circuit 510 can be further implemented to provide additional protection. Clamping circuit 510 further protects the circuitry of RF receiver front-end 500 disposed on semiconductor substrate 110 by providing a short path for large positive and negative differential voltage signals on differential RF signal path 145. Clamping circuit 510 can be particularly useful if a voltage gain is provided to the differential RF signal by balun transformer 115 or some other source.

Clamping circuit 510 includes diodes D3 and D4 coupled in series between positive-end 150 and negative-end 155 of differential RF signal path 145. The anode of diode D3 is coupled to positive-end 150 of differential RF signal path 145 and the cathode of diode D4 is coupled to negative-end 155 of differential RF signal path 145. Diodes D3 and D4 are reverse biased when the differential voltage applied across their series combination is less than 2*V_{DIODE}, where V_{DIODE} represents the turn-on voltage of diodes D3 and D4. In an embodiment, V_{DIODE} is approximately equal to +0.6 V. During normal operation, the differential RF signal coupled to differential RF signal path 160, has a differential voltage potential below 2*V_{DIODE}. Therefore, diodes D3 and D4 are reverse biased during normal operation of RF receiver front-end 500. Diodes D3 and D4 appear as a high-impedance element (i.e., an open circuit) when reverse biased.

Diodes D3 and D4 are forward biased when the differential voltage applied across their series combination is greater than 2*V_{DIODE}. Diodes D3 and D4 appear as a low-impedance element (i.e., a short circuit) when forward biased. Diodes D3 and D4 will be forward biased when large, positive RF signals are received at antenna 105. These large, positive RF signals, applied to the input terminal of semiconductor substrate 110, are shorted to negative-end 155 of differential RF signal path 145 by diodes D3 and D4.

As further illustrated in FIG. 5, clamping circuit 510 further includes diodes D5 and D6 coupled in series between positive-end 150 and negative-end 155 of differential RF signal path 145. The anode of diode D6 is coupled to negative-end 155 of differential RF signal path 145 and the cathode of diode D5 is coupled to positive-end 150 of differential RF signal path 145. Diodes D5 and D6 are reverse biased when the differential voltage applied across their series combination is greater than 2*(−V_{DIODE}), where V_{DIODE} represents the turn-on voltage of diodes D5 and D6. In an embodiment, V_{DIODE} is approximately equal to +0.6 V. During normal operation, the differential RF signal coupled to differential RF signal path 145, has a differential voltage potential greater that 2*(−V_{DIODE}). Therefore, diodes D5 and D6 are reverse biased during normal operation of RF receiver front-end 500. Diodes D5 and D6 appear as a high-impedance element (i.e., an open circuit) when reverse biased.

Diodes D5 and D6 are forward biased when the differential voltage applied across their series combination is less than 2*(−V_{DIODE}). Diodes D5 and D6 appear as a low-impedance element (i.e., a short circuit) when forward biased. Diodes D5 and D6 will be forward biased when large, negative RF signals are received at antenna 105. These large, negative RF signals, applied to the input terminal of semiconductor substrate 110, are shorted to positive-end 150 of differential RF signal path 145 by diodes D5 and D6.

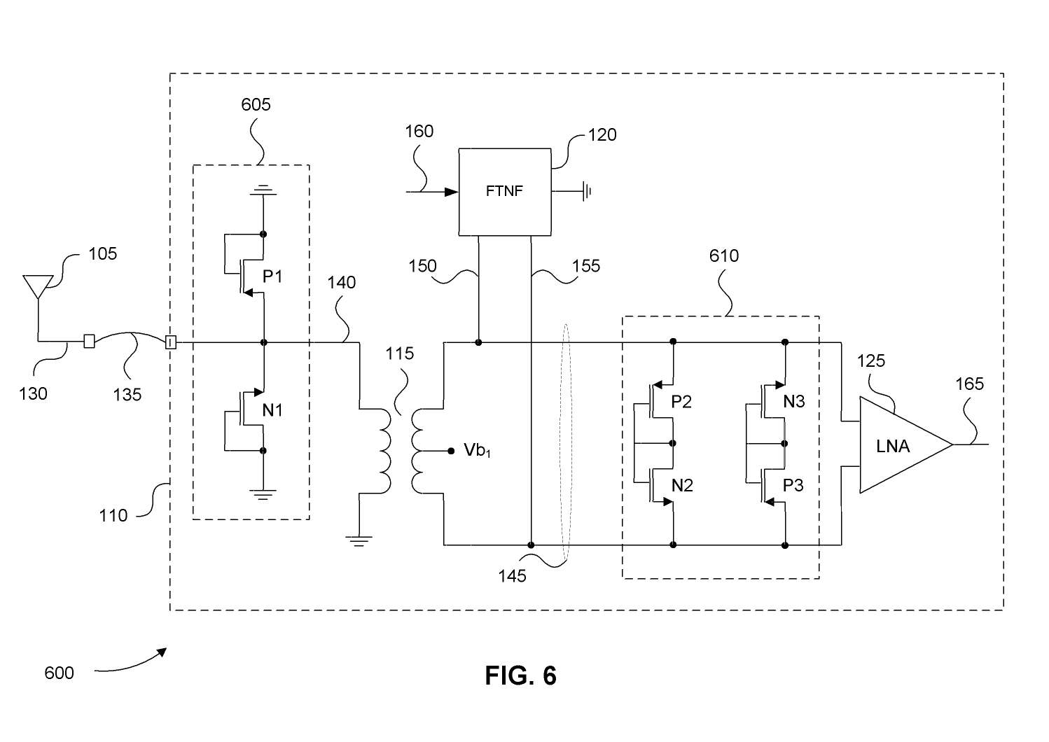

FIG. 6 illustrates a SAW-less RF receiver front-end 600 that includes circuitry for protection from large out-of-band interferers, according to embodiments of the present invention. Specifically, RF receiver front-end 600 includes two clamping circuits 605 and 610 that provide protection from large out-of-band interferers received at antenna 105. Clamping circuits 605 and 610 are implemented using transistor devices as opposed to the diode implementation of clamping circuits 505 and 510 illustrated in FIG. 5. In general, transistors can be modeled more accurately in simulations for RF applications and, as a result, may provide a desirable substitute for diode devices.

Clamping circuit 605 includes two transistors N1 and P1. In an embodiment, transistors N1 and P1 are metal-oxide semiconductor field effect transistors (MOSFETs). Specifically, transistor N1 is a n-channel MOSFET (NMOS) and transistor P1 is a p-channel MOSFET (PMOS). However, as will be appreciated by one of ordinary skill in the art, transistors N1 and P1 can be implemented using any suitable transistor technology, including bipolar junction transistors (BJTs) and junction gate field effect transistors (JFETs).

The source of transistor P1 is coupled to single-ended RF signal path 140 and the gate and drain of transistor P1 is coupled to ground. This transistor configuration, wherein the gate is directly coupled to the drain, is commonly referred to as a diode-connected transistor. Transistor P1 remains cut-off when the source of transistor P1, coupled to single-ended RF path 140, is at a voltage potential less than the absolute value of V_{TP} (i.e., |V_{TP}|), where V_{TP} is the threshold voltage of transistor P1. In an embodiment, V_{TP} is approximately equal to −0.6 V. During normal operation, the RF signal received by antenna 105 and coupled to single-ended RF signal path 140, has a voltage potential less than |V_{TP}|. Therefore, transistor P1 remains cut-off during normal operation of RF receiver front-end 600. Transistor P1 appears as a high-impedance element (i.e., an open circuit) when transistor P1 is cut-off.

Transistor P1 operates in saturation when the source of transistor P1, coupled to single-ended RF signal path 140, is at a voltage potential greater than |V_{TP}|. Transistor P1 appears as a low-impedance element (i.e., a short circuit) when transistor P1 operates in saturation. Transistor P1 will operate in saturation when large, positive RF signals are received at antenna 105. These large, positive RF signals, applied to the input terminal of semiconductor substrate 110, are shunted to ground by transistor P1.

As further illustrated in FIG. 6, the source of transistor N1 is coupled to single-ended RF signal path 140 and the gate and drain of transistor N1 is coupled to ground. This transistor configuration, wherein the gate is directly coupled to the drain, is commonly referred to as a diode-connected transistor. Transistor N1 remains cut-off when the source of transistor N1, coupled to single-ended RF path 140, is at a voltage potential greater than −V_{TN}, where V_{TN} is the threshold voltage of transistor N1. In an embodiment, −V_{TN} is approximately equal to −0.6 V. During normal operation, the RF signal received by antenna 105 and coupled to single-ended RF signal path 140, has a voltage potential greater than −V_{TN}. Therefore, transistor N1 remains cut-off during normal operation of RF receiver front-end 600. Transistor N1 appears as a high-impedance element (i.e., an open circuit) when transistor N1 is cut-off.

Transistor N1 operates in saturation when the source of transistor N1, coupled to single-ended RF signal path 140, is at a voltage potential less than −V_{TN}. Transistor N1 appears as a low-impedance element (i.e., a short circuit) when transistor N1 operates in saturation. Transistor N1 will operate in saturation when large, negative RF signals are received at antenna 105. These large, negative RF signals, applied to the input terminal of semiconductor substrate 110, are shunted to ground by transistor N1.

Although clamping circuit 605 can effectively clamp the RF signal on single-ended RF signal path 140 to a voltage within |V_{TP}| to −V_{TN}, clamping circuit 610 can be further implemented to provide additional protection. Clamping circuit 610 further protects the circuitry of RF receiver front-end 600 disposed on semiconductor substrate 110 by providing a short path for large positive and negative differential voltage signals on differential RF signal path 145. Clamping circuit 610 can be particularly useful if a voltage gain is provided to the differential RF signal by balun transformer 115 or some other source.

Clamping circuit 610 includes transistors N2, P2, N3, and P3. In an embodiment, transistors N2, P2, N3, and P3 are metal-oxide semiconductor field effect transistors (MOSFETs). Specifically, transistors N2 and N3 are n-channel MOSFETs (NMOS) and transistors P2 and P3 are a p-channel MOSFETs (PMOS). However, as will be appreciated by one of ordinary skill in the art, transistors N2, P2, N3, and P3 can be implemented using any suitable transistor technology, including bipolar junction transistors (BJTs) and junction gate field effect transistors (JFETs).

Transistors P2 and N2 are coupled in series between positive-end 150 and negative-end 155 of differential RF signal path 145. The source of transistor P2 is coupled to positive-end 150 of differential RF signal path 145 and the source of transistor N2 is coupled to negative-end 155 of differential RF signal path 145. The gate and drain of transistors P2 and N2 are coupled together, forming two diode-connected transistors. Transistors P2 and N2 are cut-off when the differential voltage applied across their series combination is less than (|V_{TP}|+V_{TN}), where V_{TP} is the threshold voltage of transistor P2 and V_{TN} is the threshold voltage of transistor N2. In an embodiment, |V_{TP}| and V_{TN} are approximately equal to +0.6 V. During normal operation, the differential RF signal coupled to differential RF signal path 145, has a differential voltage potential less than (|V_{TP}|+V_{TN}). Therefore, transistors P2 and N2 are cut-off during normal operation of RF receiver front-end 600. Transistors P2 and N2 appear as a high-impedance element (i.e., an open circuit) when cut-off.

Transistors P2 and N2 operate in saturation when the differential voltage applied across their series combination is greater than (|V_{TP}|+V_{TN}). Transistors P2 and N2 appear as a low-impedance element (i.e., a short circuit) when operating in saturation. Transistors P2 and N2 operate in saturation when large, positive RF signals are received at antenna 105. These large, positive RF signals, applied to the input terminal of semiconductor substrate 110, are shorted to the negative-end 155 of differential RF signal path 145 by transistors P2 and N2.

As further illustrated in FIG. 6, transistors P3 and N3 are coupled in series between positive-end 150 and negative-end 155 of differential RF signal path 145. The source of transistor P3 is coupled to negative-end 155 of differential RF signal path 145 and the source of transistor N3 is coupled to positive-end 150 of differential RF signal path 145. The gate and drain of transistors P3 and N3 are coupled together, forming two diode-connected transistors. Transistors P3 and N3 are cut-off when the differential voltage applied across their series combination is greater than (V_{TP}−V_{TN}), where V_{TP} is the threshold voltage of transistor P3 and V_{TN} is the threshold voltage of transistor N2. In an embodiment, V_{TP} and V_{TN} are approximately equal to −0.6 V and +0.6 V, respectively. During normal operation, the differential RF signal coupled to differential RF signal path 145, has a differential voltage potential greater that (V_{TP}−V_{TN}). Therefore, transistors P3 and N3 are cut-off during normal operation of RF receiver front-end 600. Transistors P3 and N3 appear as a high-impedance element (i.e., an open circuit) when cut-off.

Transistors P3 and N3 operate in saturation when the differential voltage applied across their series combination is less than (V_{TP}−V_{TN}). Transistors P3 and N3 appear as a low-impedance element (i.e., a short circuit) when operating in saturation. Transistors P3 and N3 operate in saturation when large, negative RF signals are received at antenna 105. These large, negative RF signals, applied to the input terminal of semiconductor substrate 110, are shorted to positive-end 150 of differential RF signal path 145 by transistors P3 and N3.

It should be noted that clamping circuits 605 and 610 advantageously attempt to minimize parasitic loading on single-ended RF signal path 140 and differential RF signal path 145. Specifically, clamping circuits 605 and 610 each avoid coupling the gates of transistors N1, P1, N2, P2, N3, and P3 to single-ended RF signal path 140 and differential RF signal path 145. This avoids the addition of the gate to source capacitance (Cgs) of each transistor to the RF signal path lines. Parasitic capacitances can adversely affect the RF signal bandwidth. The RF signal bandwidth supported by single-ended RF signal path 140 and differential RF signal path 145 is reduced as the parasitic capacitance on these lines increases.

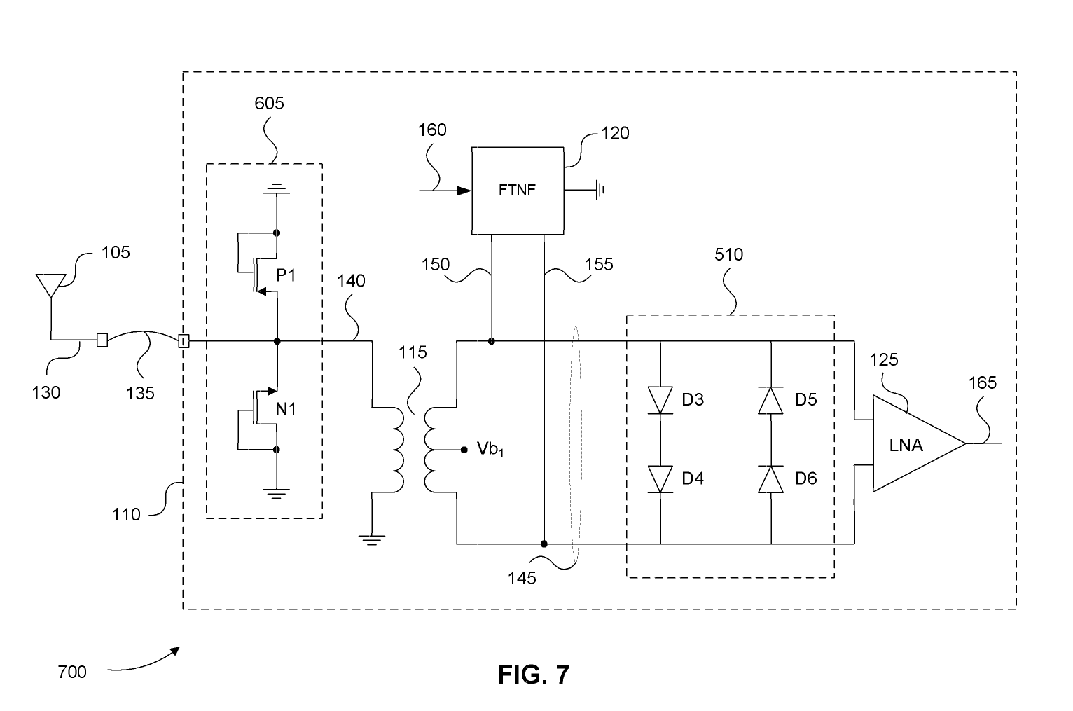

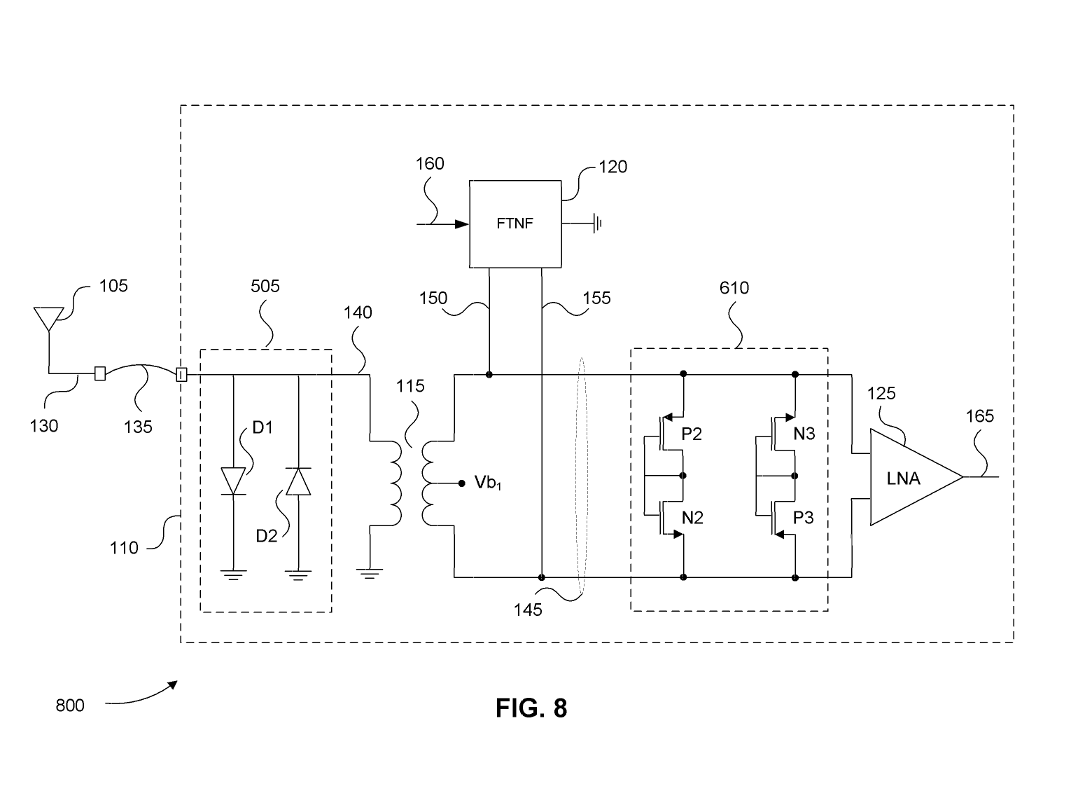

As will be appreciated by a person of ordinary skill in the art based on the teachings herein, any number of series diodes or transistors can be used within clamping circuits 505, 510, 605, and 610 to provide for desired clamping voltage levels. For example, diodes D1 and D2 in clamping circuit 505 can further include one or more additional diodes coupled in series with diodes D1 and D2. In addition, clamping circuits 505, 510, 605, and 610 are not limited to providing protection from large, out-of-band RF interferers. Rather, as will be appreciated by a person of ordinary skill in the art, clamping circuits 505, 510, 605, and 610 can provide protection from various large voltage signals coupled to single-ended RF signal path 140 and differential RF signal path 145, including large voltage signals that are non-RF. Moreover, it should be noted that any combination of clamping circuits 505, 510, 605, and 610, presented in FIGS. 5 and 6, can be used without departing from the scope and spirit of the present invention. FIGS. 7 and 8 illustrate two additional combinations of the clamping circuits presented in FIGS. 5 and 6.

Specifically, FIG. 7 illustrates a SAW-less RF receiver front-end 700 that includes clamping circuit 605 described above in regard to FIG. 6 and clamping circuit 510 described above in regard to FIG. 5. FIG. 8 illustrates a SAW-less RF receiver front-end 800 that includes clamping circuit 505 described above in regard to FIG. 5 and clamping circuit 610 described above in regard to FIG. 6.

### 4. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A radio frequency (RF) receiver comprising:
an integrated circuit pin configured to couple an RF signal received at an antenna to an RF signal path;
a clamping circuit coupled to the RF signal path;
a frequency translated notch filter (FTNF) coupled to the RF signal path and configured to attenuate interferers outside a frequency band of interest in the RF signal to provide a filtered RF signal; and
a low noise amplifier (LNA) coupled to the RF signal path and configured to provide an amplified version of the filtered RF signal at an output.

2. The RF receiver of claim 1, wherein the clamping circuit comprises:
a first diode and a second diode coupled in anti-parallel between the RF signal path and ground.

3. The RF receiver of claim 1, wherein the clamping circuit comprises:
a p-channel metal oxide semiconductor (PMOS) and a n-channel metal oxide semiconductor (NMOS), a source of the PMOS and a source of the NMOS coupled to the RF signal path, a gate and drain of the PMOS and a gate and drain of the NMOS coupled to ground.

4. The RF receiver of claim 1, wherein the clamping circuit comprises:
a first and a second diode coupled in series between a positive-end and a negative-end of the RF signal path, wherein an anode of the first diode is coupled to the positive-end of the RF signal path and a cathode of the fourth diode is coupled to the negative-end of the RF signal path; and
a third and a fourth diode coupled in series between the positive-end and the negative-end of the RF signal path, wherein a cathode of the third diode is coupled to the positive-end of the RF signal path and an anode of the fourth diode is coupled to a negative-end of the RF signal path.

5. The RF receiver of claim 1, wherein the clamping circuit comprises:
a first p-channel metal oxide semiconductor (PMOS) and a first n-channel metal oxide semiconductor (NMOS), wherein a gate and drain of the first PMOS and a gate and drain of the first NMOS are coupled together, wherein a source of the first PMOS is coupled to a positive-end of the RF signal and a source of the first NMOS is coupled to a negative-end of the RF signal; and
a second PMOS and a second NMOS, wherein a gate and drain of the second PMOS and a gate and drain of the second NMOS are coupled together, wherein a source of the second PMOS is coupled to the negative-end of the RF signal and a source of the second NMOS is coupled to the positive-end of the RF signal.

6. The RF receiver of claim 1, wherein the FTNF comprises:
a passive mixer configured to mix the RF signal received at a first mixer input and a local oscillator (LO) signal received at a second mixer input; and
a baseband impedance coupled between an output of the passive mixer and ground,
wherein the first mixer input presents a high-impedance path to ground for frequency components of the RF signal within the frequency band of interest and a low-impedance path to ground for frequency components of the RF signal outside the frequency band of interest.

7. The RF receiver of claim 6, wherein the LO signal has a duty cycle substantially equal to 25%.

8. The RF receiver of claim 6, wherein the baseband impedance includes a capacitor.

9. The RF receiver of claim 6, wherein an impedance seen by the RF signal at the first mixer input is substantially equal to the baseband impedance translated in frequency by a frequency of the LO signal.

10. A radio frequency (RF) receiver comprising:
an integrated circuit pin configured to couple an RF signal received at an antenna to a single-ended RF signal path;
a first clamping circuit coupled between the single-ended RF signal path and ground;
a balun transformer configured to transform the single-ended RF signal path into a differential RF signal path;
a frequency translated notch filter (FTNF) coupled to the differential RF signal path and configured to attenuate interferers outside a frequency band of interest in the RF signal to provide a filtered RF signal; and
a low noise amplifier (LNA) coupled to the differential RF signal path and configured to provide an amplified version of the filtered RF signal at an output.

11. The RF receiver of claim 10, wherein the first clamping circuit comprises:
a first diode and a second diode coupled in anti-parallel between the single-ended RF signal path and ground.

12. The RF receiver of claim 10, further comprising a second clamping circuit that comprises:
a first and a second diode coupled in series between a positive and a negative-end of the differential RF signal path, wherein an anode of the first diode is coupled to the positive-end of the differential RF signal path and a cathode of the second diode is coupled to the negative-end of the differential RF signal path; and
a third and a fourth diode coupled in series between the positive and the negative-end of the differential RF signal path, wherein a cathode of the third diode is coupled to the positive-end of the differential RF signal path and an anode of the fourth diode is coupled to the negative-end of the differential RF signal path.

13. The RF receiver of claim 10, further comprising a second clamping circuit that comprises:
a first p-channel metal oxide semiconductor (PMOS) and a first n-channel metal oxide semiconductor (NMOS), wherein a gate and a drain of the first PMOS and a gate and a drain of the first NMOS are coupled together, wherein a source of the first PMOS is coupled to a positive-end of the differential RF signal and a source of the first NMOS is coupled to a negative-end of the differential RF signal; and
a second PMOS and a second NMOS, wherein a gate and a drain of the second PMOS and a gate and a drain of the second NMOS are coupled together, wherein a source of the second PMOS is coupled to the negative-end of the differential RF signal and a source of the second NMOS is coupled to the positive-end of the differential RF signal.

14. The RF receiver of claim 10, wherein the FTNF comprises:
a passive mixer configured to mix the RF signal received at a first mixer input and a local oscillator (LO) signal received at a second mixer input; and
a baseband impedance coupled between an output of the passive mixer and ground,
wherein the first mixer input presents a high-impedance path to ground for frequency components of the RF signal within the frequency band of interest and a low-impedance path to ground for frequency components of the RF signal outside the frequency band of interest.

15. The RF receiver of claim 14, wherein the LO signal has a duty cycle substantially equal to 25%.

16. The RF receiver of claim 14, wherein the baseband impedance includes a capacitor.

17. The RF receiver of claim 14, wherein an impedance seen by the RF signal at the first mixer input is substantially equal to the baseband impedance translated in frequency by a frequency of the LO signal.
